(19) United States
(12) Patent Application Publication
(10) Pub. No.: US 2009/0076874 A1
(43) Pub. Date: Mar. 19, 2009

(54) Method and Tool for Optimized System Maintenance

(75) Inventors: Wolfgang Gross, Erlangen (DE); Bernd Kerl, Nurnberg (DE)

Correspondence Address: CROWELL & MORING LLP;INTELLECTUAL PROPERTY GROUP, P.O. BOX 14300, WASHINGTON, DC, 20044-4300, US

(73) Assignees: Siemens Aktiengesellschaft, Munich (DE); Siemens Power Generation , Inc., Orlando, FL (US)

(21) Appl. No.: 11/917,399

(22) PCT Filed: Jun. 30, 2005
(86) PCT No.: PCT/US2005/023087

§ 371 Date: Dec. 13, 2007

(51) Int. Cl. G06Q 10/00; G06F 15/00

(52) U.S. Cl. 705/8; 702/184

(57) ABSTRACT

A method for maintaining a system consisting of a plurality of components, comprises the steps of collecting maintenance information for each component of the system for which maintenance information is available; providing a maintenance schedule for components of the system; operating the system; and maintaining the system wherein during scheduled maintenance of a component information about the status of that component is acquired, during a failure of a component information about the failure of that component is acquired, and modifying the maintenance schedule according to the acquired information.

### TECHNICAL FIELD

The present application relates to automation systems and in particular to the optimized maintenance of such a system.

### BACKGROUND OF THE INVENTION

In modern factories or plants, engineering systems are provided to define processing steps in manufacturing and/or controlling certain process steps within the system. To this end, these engineering systems usually comprise a plurality of mechanical and/or electrical components, such as process technology field devices, control devices, drives, sensors, microprocessors, personal computers, software, etc. Each component often consists of hardware and software/firmware, additional aids for configuration, parameterization, and diagnosis, as well as information for operating and maintaining the component. Such information is provided by the specific vendor of the component or if the component is designed in house, by the specific engineering team.

System manufacturers combine these components provided by specific vendors if necessary with their own components to design and build complex automation systems. The operator of such a designed system relies on the specific information provided by the system manufacturer and vendors to perform the required steps for maintaining the system operable. The most critical factor in operating automation systems is down time due to failure of a component. Therefore, maintaining the system operable is one of the most important tasks of a system operator. Specific maintenance teams monitor the system and repair specific components in case of a system failure. However, to keep down time at a minimum, preventive maintenance is required. Thus, failure can be avoided by exchanging specific parts according to a maintenance plan or scheme. Such a scheme or plan is simply defined according to the information provided by the system designer or vendor of a component which informs, for example, how often a specific part should be replaced.

Nevertheless, many factors influence the operability of specific parts of a complex system. Thus, a maintenance scheme/plan as described above is far from being optimized and does not take specific influencing factors into account. For example, prescribed maintenance intervals might be too long or too short due to the specific design of the system or specific usage of devices. Hence, either avoidable system failure or unnecessary maintenance may occur, thus, increasing operating costs of the respective system.

### SUMMARY OF THE INVENTION

A method for maintaining a system consisting of a plurality of components, according to an exemplary embodiment of the invention comprises the steps of collecting maintenance information for each component of the system for which maintenance information is available; providing a maintenance schedule for components of the system; operating the system; and maintaining the system wherein during scheduled maintenance of a component information about the status of that component is acquired, during a failure of a component information about the failure of that component is acquired, and modifying the maintenance schedule according to the acquired information.

The method may further comprise the step of determining maintenance information for components of the system for which no maintenance information is available. The information acquired during a scheduled maintenance may indicate that a service interval is too long, correct, or too short. The step of modifying may include the step of adjusting the service interval. The method may further comprise the step of determining information about interrelationship of components. The method further may comprise the step of determining information about environmental conditions of a location of at least one component. The method may further comprise the step of providing feedback information for a system designer. The method may further comprise the step of providing feedback information for a component manufacturer. The feedback information can be automatically generated via an electronic messaging system.

A system for optimizing system maintenance according to another exemplary embodiment comprises a plurality of components; a data network coupling the plurality of components; and a maintenance unit for collecting and processing information generated during normal processing as well as during maintenance of components of the system according to a predefined maintenance schedule, wherein the predefined maintenance schedule is modified by the maintenance tool according to the processed information.

The information may include maintenance information and/or normal processing information. Each component may comprise a memory unit for storing the maintenance information. The memory unit may store information for the component itself and for subordinated components. The system may further comprise means for generating electronic messages including the collected maintenance information and for providing a vendor and/or system designer with the electronic message. The system may further comprise sensors for sensing environmental conditions of a component.

A method for designing and operating a system consisting of a plurality of components according to another exemplary embodiment of the present invention comprising the steps of designing a system using a plurality of components; collecting maintenance information for each component of the system; scheduling maintenance service for components of the system; operating the system; maintaining the system wherein during scheduled maintenance of a component information about the status of that component is acquired, during a failure of a component information about the failure of that component is acquired, and modifying the maintenance schedule according to the acquired information. At least one component can be provided by an external vendor or component manufacturer. The method may further comprise the step of determining maintenance information for components of the system for which no maintenance information is available. The information acquired during a scheduled maintenance may indicate any kind of deviation from a predefined status. The deviation may indicate that a service interval is too long, correct, or too short, and wherein the step of modifying includes the step of adjusting the service interval. The method may further comprise the step of determining information about interrelationship of components. The method may further comprise the step of determining information about environmental conditions of a location of at least one component. The method may further comprise the step of providing feedback information for a system designer. The method may further comprise the step of providing feedback information for a vendor or component manufacturer. The feedback information can be automatically generated via an electronic messaging system.

### BRIEF DESCRIPTION OF THE DRAWINGS

FIG. 1 shows an exemplary automation system according to the prior art;

FIG. 2 shows a first exemplary flow chart of a system design and operation according to the present invention;

FIG. 3 shows an exemplary embodiment of an automation system according to the present invention;

FIG. 4 shows a second exemplary flow chart of a system design and operation according to the present invention.

### DETAILED DESCRIPTION OF THE PREFERRED EMBODIMENTS

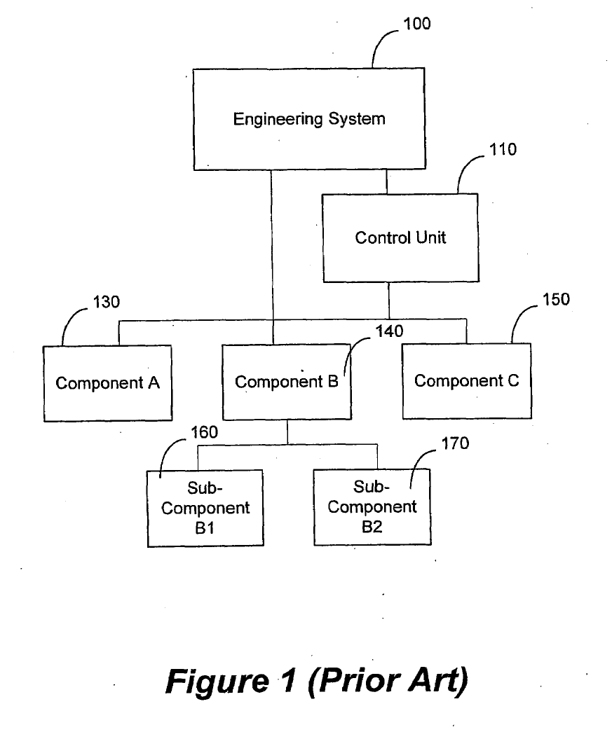

FIG. 1 shows a conventional automation system consisting of an engineering system 100 coupled with a control unit 110 and a plurality of components 130-170, for example as shown component A, B, C. In this exemplary system, component B further comprises sub-components B1 and B2. Each component 130-170 might be provided by a different vendor and might comprise specific performance characteristics. Each vendor might recommend a certain maintenance plan and depending on the type of component a certain replacement schedule for specific parts, for example, wear and tear elements. The respective maintenance personnel will, thus, follow these instructions regardless of the overall characteristics of the entire system. Thus, certain maintenance services could be performed too late or too early. In addition, no feedback will generally be provided to the vendor or system designer. The maintenance personnel might at most adjust the maintenance schedule for the specific part. Nevertheless, any influence of the specific part and its specific needs on the entire system will be completely neglected.

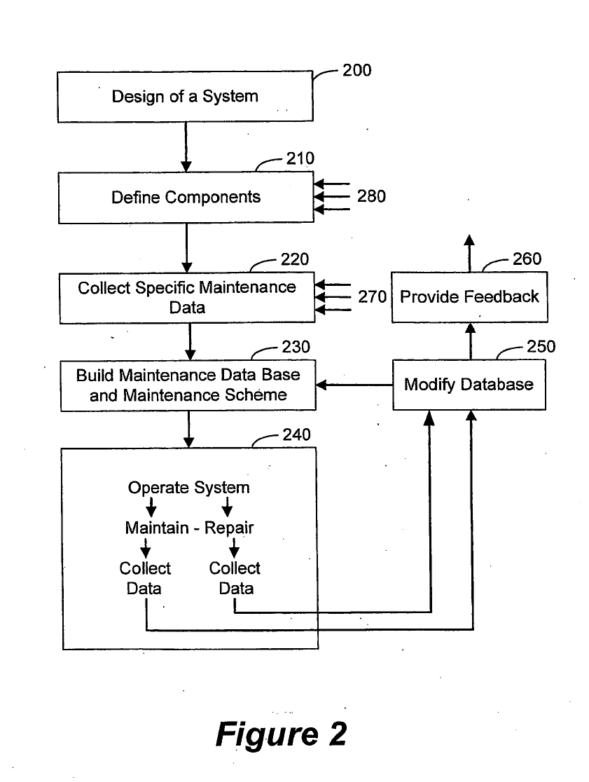

Thus, according to the present invention, a new approach for an improved method and tool for optimized maintenance is proposed. For example, FIG. 2 shows a flow chart of specific steps in the design and operation of a system consisting of a plurality of independent and/or dependent components. In a first step 200, the manufacturer of, for example, an automation system, designs the system using a plurality of, e.g., standard components, customized standard components, and/or specifically designed components. In step 210, these components and their specific properties are defined using, if necessary, external information, for example, provided by the respective vendor as indicated with arrows 280. According to this information, once the overall system is designed, a specific maintenance schedule/plan is defined in the following steps 220 and 230. To this end, specific information about each component is collected in step 220 using, for example, external information about specific properties, wear and tear of each component, and recommended maintenance intervals and other maintenance data as indicated by arrows 270. If no information is available, then the operator/user may define a custom maintenance schedule/plan if the respective component requires maintenance. In step 230, these data are stored in a custom maintenance data base and used to design a custom maintenance scheme/plan taking into consideration the respective inherent properties of each component as well as their particular placement within the system. Thus, for example, specific environmental influences created either by the location or by adjoining components can be taken into account. Furthermore, specific mechanical and/or electrical influences of certain components on other components can also be considered. Thus, any influence by any component as well as specific influences of a component location on its performance can be taken into account.

However, many other factors might not been known at the time of the design. Thus, as shown in step 240, during operation of the system, certain maintenance services and/or repair services will be performed. Each service, whether maintenance or repair, will provide the respective personnel with additional data about the respective task which has been performed. For example, a scheduled maintenance service might require a replacement of a wear and tear part. For example, a valve might require replacement after 10,000 cycles. However, the exchange of this part might show, that the respective part does not show the anticipated wear and replacement was too early. Also, a unscheduled repair service will provide information of, for example, a higher wear and tear of a specific part than anticipated, for example, the valve might show significant damage after only 8,000 cycles. Also other components might show measurable wear and tear. For example, a electrically operated brake needs maintenance after 5,000 activations according to the vendor. However, the service might show only 50% wear and tear. Additional influencing factors might be discovered due to specific types of failures, such as, over heating, additional mechanical stress factors, etc. In particular, due to the specific maintenance/repair service, the respective personnel might be able to deduct certain cross-influential factors which have not been considered during the design phase. This information can now be used by a maintenance tool in step 250 to modify the data base and the maintenance schedule/plan. Thus, an adaptive process takes place during which an optimized customary maintenance schedule/plan can be developed. Furthermore, the respective data base can also be used to generate information about certain cross-influential factors created by the combination of two or more components that are linked in specific ways. Thus, whenever certain combinations of components are used in a new design, these specific cross-influential factors can be taking into account.

A maintenance service might provide predefined information that can be forwarded automatically or manual to the maintenance tool. For example, the following choices might be available for the service personnel:
Maintenance service was performed to late (component failure occurred)
Maintenance service was absolutely necessary
Maintenance service was necessary
Maintenance service could have been performed later (optional include time interval)
Maintenance service was unnecessary

The maintenance service might further provide information about an improved maintenance service plan, recommendations to the vendor, and any actual data about the specific component/part. This information can be directly forwarded to the maintenance tool and in addition, this information can be directly stored in the respective component if the component provides for such a storage feature.

The combination of certain components and their respective effect on the overall system and on specific components can also be generated. For example, using component A in a specific combination with component B might result in 10% increase of wear and tear of part X, whereas a combination of component B and C might decrease a mechanical stress on a specific part Y in component B. Furthermore, environmental factors such as temperature, humidity, pressure, etc. might have positive or negative influence on the performance of certain parts which might not be known or provided by a vendor. Also, a combination of components and environmental conditions might cause certain effects on the overall or specific performance of certain components or parts. All these information can be collected in step 250 during the operation of the system and be used to improve the performance of the system and keep the down time of the system at a minimum.

FIG. 2 also shows an additional optional step 260 of providing feedback. In this step, the above described specific information can be forwarded to the respective vendors and/or to the designers of the system. This should not be an automatic action without influence of the maintenance personnel to avoid that proprietary information is sent to a vendor. Some of this feedback information can be generated automatically and, for example, be provided to the vendor via email, SMS, in form of a letter, or any other suitable communication form. Thus, the method and tool for optimizing the maintenance service allows not only for improving the respective automation system but also to provide vendors with specific data which can be either used to inform other customers about specific properties of the component or their parts or to improve the respective parts of the components or to improve the recommended maintenance plans for a component. Furthermore, the basic knowledge about specific components can be improved and adapted to allow a better design of new systems. The feedback may comprise, for example, identification and maintenance data of the specific component which can be vendor- or system-specific, maintenance plan recommended by the vendor, application information, and experience of the user/maintenance personnel.

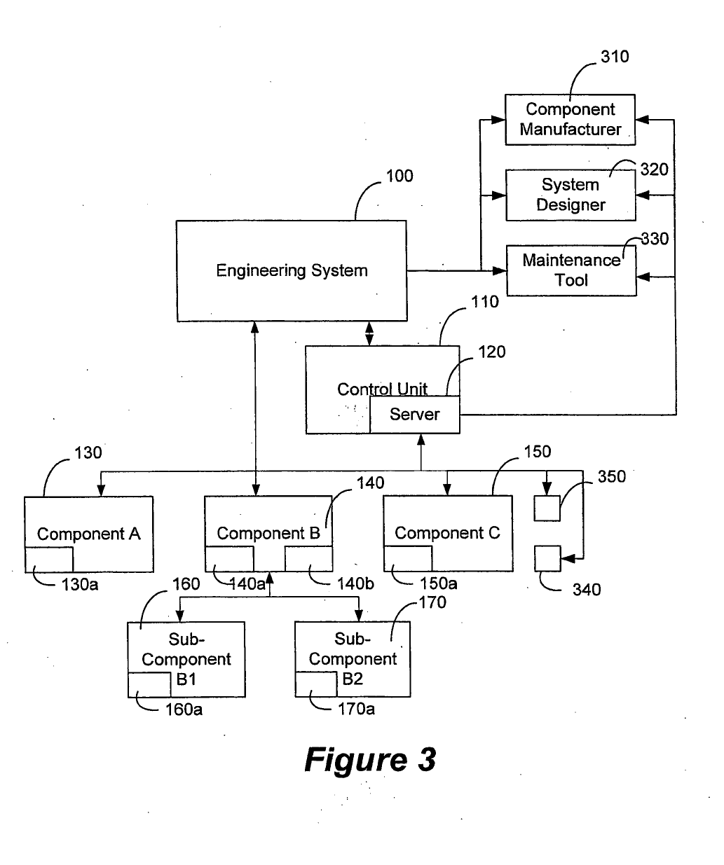

FIG. 3 shows how operator, designer, and vendor of an automation system can benefit from the optimized maintenance tool and method according to the present invention. In FIG. 3, the same system as shown in FIG. 1 is improved by a maintenance tool 330 as described in FIG. 2. To this end, for example, a server 120 is integrated into the control unit 110 and is coupled with the maintenance tool 330. A network couples all components 130-170 with the engineering system 100 and/or the server 120. Furthermore, each component may comprise a memory unit 130a, 140a, 150a, 160a, and 170a for storing the respective maintenance data developed during operation of the system. In particular components with sub-components, such as, component 140 may comprise an additional memory unit 140b which contains the information of memory units 160a and 170a of sub-components 160 and 170. The server 120 may forward the acquired data to the maintenance tool 330 which processes these data as described above. Furthermore, the server 120 may forward the same or specifically selected data to the component manufacturer/vendor and the system designer. To this end specific filters can be implemented to provide the respective parties with only suitable data. Furthermore, or alternatively the engineering system can provide the information about the components for example, via Internet, directly to the maintenance tool 330, the component manufacturer/vendor 310, and the system designer 320. Also, certain environmental characteristics of the specific location or specific measurable parameters of a component can be directly measured. Component 150 in FIG. 3, for example, is equipped with two sensors 340 and 350 which are coupled with the network to provide the respective data. These sensors may measure, temperature, pressure, stress, etc.

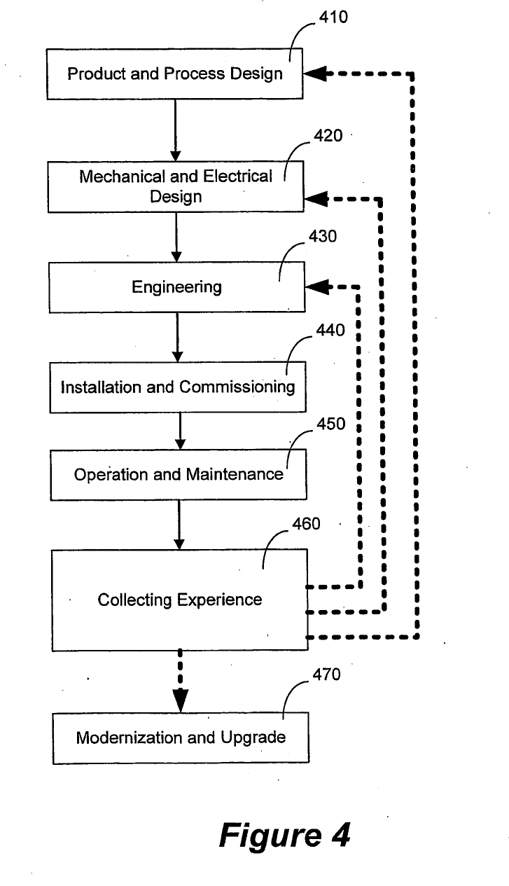

FIG. 4 shows the generally different influences of the optimized maintenance tool and method on different stages of the development of an automation system. A simplified flow chart as shown in FIG. 4 shows, for example, a first step 410 in which the product or process is designed. In the following step 420, the specific mechanical and electrical designs are made. Engineering takes place in the following step 430. After installation and commissioning in step 440, the system is operated and maintained in step 450. This leads to the step 460 of collecting experience as described above in the specific embodiments. The dotted arrows show which steps in this process, in particular for future developments can be influenced by such a method. The acquired experience leads to information and data that might improve the different design phases in step 410-430 as well as in the improvement of an existing system, for example, as shown with step 470 indicating modernization and upgrade of an existing system.

What is claimed is:

1. A method for maintaining a system consisting of a plurality of components, comprising the steps of:
collecting maintenance information: for each component of the system for which maintenance information is available;
providing a maintenance schedule for components of the system;
operating said system; and
maintaining said system wherein:
during scheduled maintenance of a component information about the status of that component is acquired;
during a failure of a component information about the failure of that component is acquired; and
modifying the maintenance schedule according to the acquired information.

2. The method according to claim 1, further comprising the step of determining maintenance information for components of the system for which no maintenance information is available.

3. The method according to claim 1, wherein the information acquired during a scheduled maintenance indicates that a service interval is too long, correct, or too short.

4. The method according to claim 3, wherein the step of modifying includes the step of adjusting said service interval.

5. The method according to claim 1, further comprising the step of determining information about interrelationship of components.

6. The method according to claim 1, further comprising the step of determining information about environmental conditions of a location of at least one component.

7. The method according to, claim 1, further comprising the step of providing feedback information for a system designer.

8. The method according to claim 1, further comprising the step of providing feedback information for a component manufacturer.

9. The method according to claim 7, wherein the feedback information is automatically generated via an electronic messaging system.

10. A system for optimizing system maintenance comprising:
a plurality of components;
a data network coupling the plurality of components;
a maintenance unit for collecting and processing information generated during normal processing as well as during maintenance of components of the system according to a predefined maintenance schedule, wherein the predefined maintenance schedule is modified by the maintenance tool according to the processed information.

11. The system according to claim 10, wherein the information includes maintenance information and/or normal processing information.

12. The system according to claim 10, wherein each component comprises a memory unit for storing said maintenance information.

13. The system according to claim 12, wherein the memory unit stores information for the component itself and for subordinated components.

14. The system according to claim 10, further comprising means for generating electronic messages including said collected maintenance information and for providing a vendor and/or system designer with said electronic message.

15. The system according to claim 10, further comprising sensors for sensing environmental conditions of a component.

16. A method for designing and operating a system consisting of a plurality of components, comprising the steps of:
designing a system using a plurality of components;
collecting maintenance information for each component of the system;
scheduling maintenance service for components of the system;
operating said system; and
maintaining said system wherein:
during scheduled maintenance of a component information about the status of that component is acquired;
during a failure of a component information about the failure of that component is acquired; and
modifying the maintenance schedule according to the acquired information.

17. The method according to claim 16, wherein at least one component is provided by an external vendor or component manufacturer.

18. The method according to claim 16, further comprising the step of, if necessary, determining maintenance information for components of the system for which no maintenance information is available.

19. The method according to claim 16, wherein the information acquired during a scheduled maintenance indicates any kind of deviation from a predefined status.

20. The method according to claim 19, wherein the deviation indicates that a service interval is too long, correct, or too short, and wherein the step of modifying includes the step of adjusting said service interval.

21. The method according to claim 16, further comprising the step of determining information about interrelationship of components.

22. The method according to claim 16, further comprising the step of determining information about environmental conditions of a location of at least one component.

23. The method according to claim 16, further comprising the step of providing feedback information for a system designer.

24. The method according to claim 17, further comprising the step of providing feedback information for a vendor or component manufacturer.

25. The method according to claim 24, wherein the feedback information is automatically generated via an electronic messaging system.
